(19) United States
(12) Patent Application Publication
(10) Pub. No.: US 2017/0171634 A1
(43) Pub. Date: Jun. 15, 2017

(54) METHOD AND ELECTRONIC DEVICE FOR PUSHING RESERVATION MESSAGE

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventors: Xiaoliang HU, Tianjin (CN); Yu WANG, Tianjin (CN); Qi ZHANG, Tianjin (CN)

(21) Appl. No.: 15/241,242

(22) Filed: Aug. 19, 2016

Related U.S. Application Data
(63) Continuation of application No. PCT/CN2016/088446, filed on Jul. 4, 2016.

(30) Foreign Application Priority Data
Dec. 15, 2015 (CN) 2015109548270

(51) Int. Cl. H04N 21/488; H04N 21/2668; H04N 21/234; H04N 21/2187; H04L 29/06; H04L 29/08

(52) U.S. Cl. CPC H04N 21/4882; H04L 65/4076; H04L 67/26; H04N 21/23424; H04N 21/2187; H04N 21/2668; H04L 61/6022

(57) ABSTRACT

Disclosed are a method and electronic device for pushing reservation message, wherein the method includes: receiving a reservation request to subscribe to a live video sent by a first client terminal; determining a user reservation relationship according to the reservation request; after an event update notification of the live video is received, determining the user identification to which the reservation message is needed to be pushed, and determining a second client terminal to which the reservation message is needed to be pushed; and pushing a reservation message of the live video to the second client terminal. According to the method, a globally unique live broadcast video identification is set for the live video of each subsystem, and accordingly, a user may receive an alert message or a notification in real-time and synchronously on any terminal.

### CROSS REFERENCE TO RELATED APPLICATIONS

This application is a continuation of International Application No. PCT/CN2016/088446, filed on Jul. 4, 2016, which is based upon and claims priority to Chinese Patent Application No. 201510954827.0, filed on Dec. 15, 2015, and titled “Method and Device for Pushing Reservation Message”, the entire contents of which are incorporated herein by reference.

### TECHNICAL FIELD

The disclosure relates to the technical field of pushing message, and specifically relates to a method and electronic device for pushing reservation message.

### BACKGROUND

With the development of Internet technology, the concept of live broadcast has new expansion and development, and now more people concern about the network live broadcast, especially concern more about network video live broadcast. Users may watch ball games, sports events, major events and news online through network signals, so that the public has a broad and free choice of space.

In order to remind users to watch interested live broadcast videos, the users may subscribe to races, vocal concert live and other events in client terminals, such as mobile phones, smart televisions, etc., and after receiving alert messages and notifications, the users may click the alert messages and the notifications to watch the live video instantly and enter designated channels.

In the process of implementing the disclosure, the inventor finds that at least the following problems exist in the prior art: the device at present can only support the watching of a live broadcast on a single device submitting the subscribed event. When a user wants to watch a live broadcast, the user can only watch the live broadcast through a fixed terminal, and the unification of multiple terminals and multiple devices cannot be achieved.

### SUMMARY

In order to overcome the defect in the prior art that after subscribe to a live broadcast, a user can only watch the live broadcast on the equipment from which the subscribed event is submitted, according to one aspect of the disclosure, a method for pushing a reservation message is provided.

In the first place, a method for pushing a reservation message provided by the embodiment of the disclosure includes:
receiving a reservation request to subscribe to a live video sent by a first client terminal, the reservation request comprising a user identification and a live video identification which globally uniquely corresponds to the live video;
determining a user reservation relationship according to the reservation request, where the user reservation relationship comprises one or more client terminals associated with the user identification;
after an event update notification of the live video is received, determining the user identification to which the reservation message is needed to be pushed according to the live video identification, and determining a second client terminal to which the reservation message is needed to be pushed according to the user reservation relationship; and
pushing a reservation message of the live video to the second client terminal, and indicating the second client terminal to play the live video according to the reservation message.

In the above technical solution, the method also includes:
acquiring same or different video flags of a live video in different subsystems, and globally unifying all video flags of the live video into a same live video identification.

In the above technical solution, determining a second client terminal to which the reservation message is needed to be pushed according to the user reservation relationship comprises:
determining one or more client terminals associated with the user identification according to the user reservation relationship; and
selecting a client terminal in a logged-in state as the second client terminal to which the reservation message is needed to be pushed.

In the above technical solution, selecting a client terminal in a logged-in state as the second client terminal to which the reservation message is needed to be pushed comprises:
determining client terminals in the logged-in state according to the user identification; and
selecting one client terminal from the client terminals in the logged-in state according to a preset rule, and taking the selected client terminal as a second client terminal.

In the above technical solution, the user identification is one or more of a user account, a mobile phone number, or a client terminal's MAC address.

In the second place, the embodiment of the disclosure further provides a non-transitory computer-readable storage medium storing executable instructions that, when executed by an electronic device, cause the electronic device to executing the above method for pushing reservation message.

In the third place, the embodiment of the disclosure further provides an electronic device, comprising: at least one processor; and a memory communicably connected with the at least one processor for storing instructions executable by the at least one processor, wherein execution of the instructions by the at least one processor causes the at least one processor to executing any of the above method for pushing reservation message

According to the method and electronic device for pushing a reservation message, provided by the embodiments of the disclosure, a globally unique live video identification is set for a live video of each subsystem, so that after a reservation request of a client terminal is received, the reservation message may be transmitted to all associated second client terminals according to the live video identification, and a user may receive an alert message or a notification in real-time and synchronously on any terminal. Meanwhile, the notification of the reservation message is globally unique, so as to avoid repeated reminding of a same reservation event.

Other characteristics and advantages of the disclosure will be stated in the follow-up description, and partially become apparent in the description, or will be understood by implementation of the disclosure. The purpose and other advantages of the disclosure can be achieved and obtained through the description, claims, and drawings.

Hereinafter, the technical solution of the disclosure is further described in details through the drawings and embodiments.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of the method for pushing a reservation message in the embodiment of the disclosure;

FIG. 2 is a flow diagram of the method for pushing a reservation message in the embodiment 1 of the disclosure;

FIG. 3 is a first structure diagram of the device for pushing a reservation message in the embodiment of the disclosure;

FIG. 4 is a second structure diagram of the device for pushing a reservation message in the embodiment of the disclosure;

FIG. 5 is a structure diagram of the processing module in the embodiment of the disclosure;

FIG. 6 is a structure diagram of the processing unit in the embodiment of the disclosure; and

FIG. 7 is a structural block diagram of the electronic device for pushing a reservation message in the embodiment of the disclosure.

### DETAILED DESCRIPTION

In order to make the object, the technical solution and the advantages of the embodiments of the disclosure clearer, hereinafter, the technical solution in the embodiments of the disclosure is clearly and completely described with reference to the drawings in the embodiments of the disclosure, and obviously, the described embodiments are part of the embodiments of the present application rather than all the embodiments. On the basis of the embodiments of the disclosure, all other embodiments obtained by those skilled in the art without making creative works belong to the protection scope of the present application.

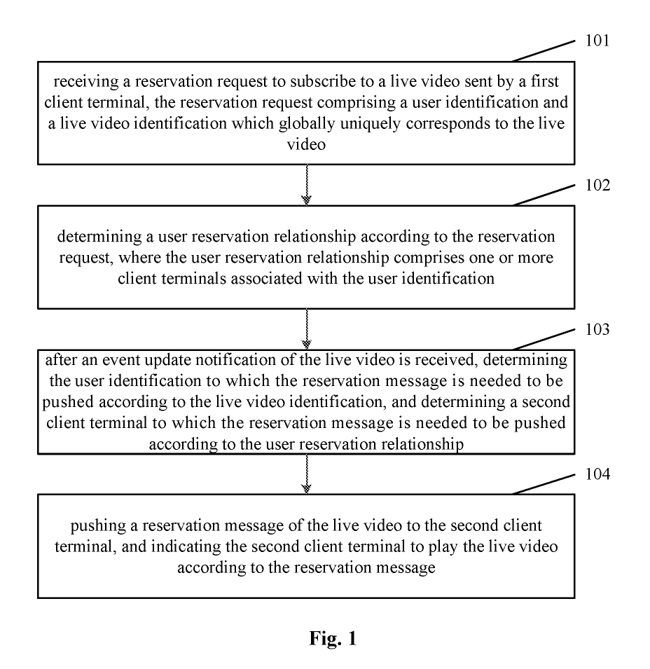

According to the embodiment of the disclosure, a method for pushing a reservation message is provided, as shown in FIG. 1, the method includes the Steps 101-104.

S101 includes receiving a reservation request to subscribe to a live video sent by a first client terminal, the reservation request comprising a user identification and a live video identification which globally uniquely corresponds to the live video.

In the embodiments of the disclosure, the first client terminal is a client terminal submitting a reservation request which is used for subscribing to a live broadcast video that a user needs to watch, where the reservation request includes a user identification and a live video identification which globally uniquely corresponds to the live video. In the embodiment of the disclosure, the user identification is used for identifying user information, and specifically, may be one or more of a user account, a mobile phone number, or a client terminal's MAC address; and the live video identification is a globally unique identification.

Specifically, in the embodiment of the disclosure, a globally unique live video identification needs to be preset for each live video, which specifically includes: acquiring same or different video flags of a live video in different subsystems, and globally unifying all video flags of the live video into a same live video identification. For example, a sports competition A exists in live video resources of a media resource library, and a same sports competition A also exists in the live video resources of a live broadcast hall, but because the two are distributed in different subsystems (one is located in the system of the media resource library, and the other is located in the system of the live broadcast hall), both have different identifications. In the embodiment of the disclosure, the identifications in different subsystems are unified into a globally unique live video identification, so that a reservation message may be transmitted to multiple subsystems, such as the media resource library or the live broadcast hall, according to the live video identification.

S102 includes determining a user reservation relationship according to the reservation request, where the user reservation relationship comprises one or more client terminals associated with the user identification.

In the embodiment of the disclosure, the same user may be associated with multiple devices. For example, a cloud service account of the user logs in both a mobile phone client B and a smart television client C, that is to say, the cloud service account (i.e. the user identification) is associated with both the mobile phone client B and the smart television client C. It should be noted that generally, a user sends a reservation request through the associated client terminals, but the user may also send a reservation request associated with other client terminals through an unassociated client terminal.

S103 includes after an event update notification of the live video is received, determining the user identification to which the reservation message is needed to be pushed according to the live video identification, and determining a second client terminal to which the reservation message is needed to be pushed according to the user reservation relationship.

Specifically, when a server determines event update of a live video (i.e., when the current time reaches a time point at which a live video subscribed by a user starts to play), it may be determined, according to the live video identification of the live video to which a time update notification has occurred, which user identifications subscribed the live video, and then the user identification to which the reservation message is needed to be pushed is determined. Meanwhile, a second client terminal to which the reservation message is needed to be pushed is determined according to the user reservation relationship.

In the embodiment of the disclosure, the second client terminal is a client terminal for receiving a reservation message pushed by the server, and may be the same as or different from the first client terminal according to actual conditions specifically.

Where, determining a second client terminal to which the reservation message is needed to be pushed according to the user reservation relationship in S103 specifically includes Steps A1-A2:
Step A1 includes determining one or more client terminals associated with the user identification according to the user reservation relationship; and
Step A2 includes selecting a client terminal in a logged-in state as the second client terminal to which the reservation message is needed to be pushed.

Where selecting a client terminal in a logged-in state as the second client terminal to which the reservation message is needed to be pushed in the Step A2 specifically includes the Steps B1-B2:
Step B1 includes determining client terminals in the logged-in state according to the user identification; and
Step B2 includes selecting one client terminal from the client terminals in the logged-in state according to a preset rule, and taking the selected client terminal as a second client terminal.

S104 pushing a reservation message of the live video to the second client terminal, and indicating the second client terminal to play the live video according to the reservation message.

According to the method for pushing a reservation message, provided by the embodiments of the disclosure, a globally unique live video identification is set for a live video of each subsystem, so that after a reservation request sent by a client terminal is received, the reservation message may be transmitted to all associated second client terminals according to the live video identification, and a user may receive an alert message or a notification in real-time synchronously on any terminal. Meanwhile, the notification of the reservation message is globally unique, so as to avoid repeated reminding of a same reservation event.

Hereinafter, the flow of the method is described in details through one embodiment.

### Embodiment 1

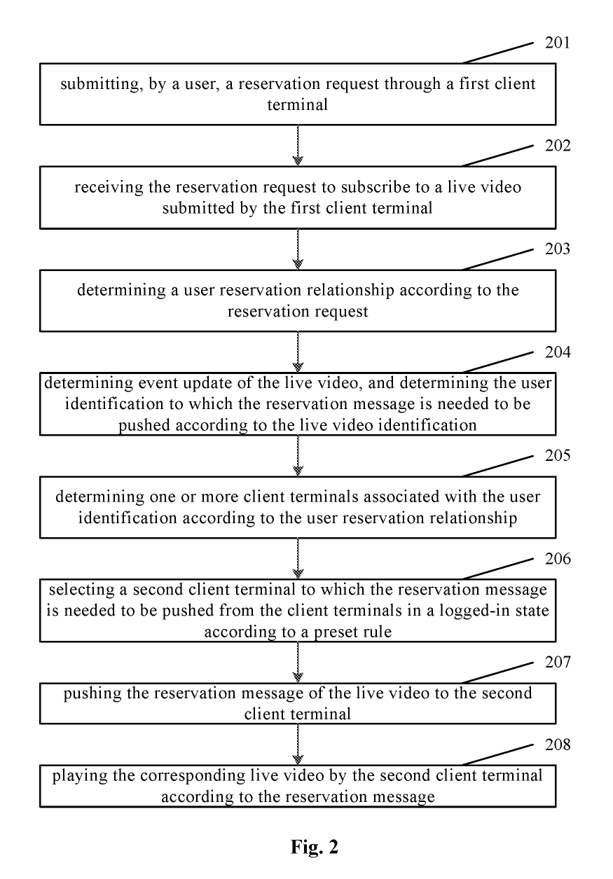

In the embodiment 1, a user submits a reservation request through a first client terminal and receives a reservation message at a second client terminal. Specifically, as shown in FIG. 2, the method includes Steps 201-208.

S201 includes submitting, by a user, a reservation request through a first client terminal.

In the embodiment 1, the reservation request includes a user identification and a live video identification which globally uniquely corresponds to a live video.

S202 includes receiving the reservation request to subscribe to a live video submitted by the first client terminal.

S203 includes determining a user reservation relationship according to the reservation request.

Where the user reservation relationship includes one or more client terminals associated with the user identification, and one of the associated client terminals is a second client terminal.

S204 includes determining event update of the live video, and determining the user identification to which the reservation message is needed to be pushed according to the live video identification.

S205 includes determining one or more client terminals associated with the user identification according to the user reservation relationship.

S206 includes selecting a second client terminal to which the reservation message is needed to be pushed from the client terminals in a logged-in state according to a preset rule.

S207 includes pushing the reservation message of the live video to the second client terminal.

S208 includes playing the corresponding live video by the second client terminal according to the reservation message.

According to the method for pushing a reservation message, provided by the embodiment 1 of the disclosure, a globally unique live video identification is set for a live video of each subsystem, so that after a reservation request of a client terminal is received, the reservation message may be transmitted to all associated second client terminals according to the live video identification, and a user may receive an alert message or a notification in real-time and synchronously on any terminal. Meanwhile, the notification of the reservation message is globally unique, so as to avoid repeated reminding of a same reservation event.

The flow of a method for pushing a reservation message is described in details above, the method may also be implemented through a corresponding device, and hereinafter, the structure and functions of the device is described in details.

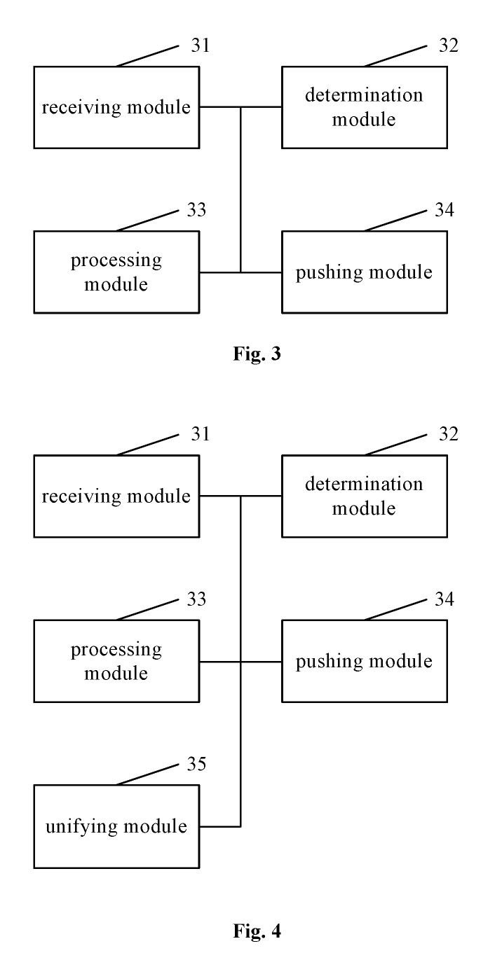

A device for pushing a reservation message, provided by the embodiments of the disclosure, as shown in FIG. 3, includes: a receiving module 31, a determination module 32, a processing module 33, and a pushing module 34.

The receiving module 31 is configured for receiving a reservation request to subscribe to a live video sent by a first client terminal, the reservation request comprising a user identification and a live video identification which globally uniquely corresponds to the live video.

The determination module 32 is configured for determining a user reservation relationship according to the reservation request, where the user reservation relationship comprises one or more client terminals associated with the user identification.

The processing module 33 is configured for after an event update notification of the live video is received, determining the user identification to which the reservation message is needed to be pushed according to the live video identification, and determining a second client terminal to which the reservation message is needed to be pushed according to the user reservation relationship.

The pushing module 34 is configured for pushing a reservation message of the live video to the second client terminal, and indicating the second client terminal to play the live video according to the reservation message.

Optionally, as shown in FIG. 4, the device further includes:
a unifying module 35, which is configured for acquiring same or different video flags of a live video in different subsystems, and globally unifying all video flags of the live video into a same live video identification.

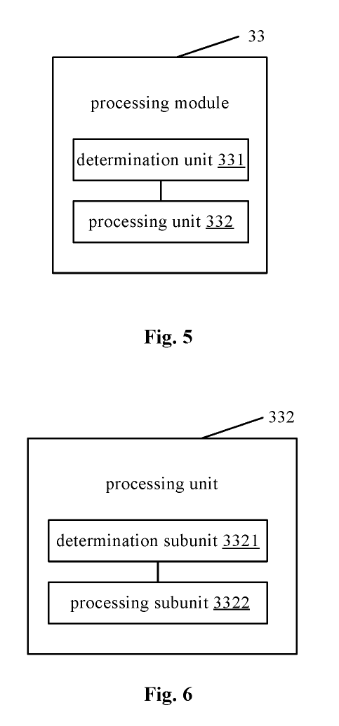

Optionally, as shown in FIG. 5, the processing module 33 includes: a determination unit 331 and a processing unit 332.

The determination unit 331 is configured for determining one or more client terminals associated with the user identification according to the user reservation relationship.

The processing unit 332 is configured for selecting a client terminal in a logged-in state as the second client terminal to which the reservation message is needed to be pushed.

Optionally, as shown in FIG. 6, the processing unit 332 includes: a determination subunit 3321 and a processing subunit 3322.

The determination subunit 3321 is configured for determining client terminals in the logged-in state according to the user identification.

The processing subunit 3322 is configured for selecting one client terminal from the client terminals in the logged-in state according to a preset rule, and taking the selected client terminal as a second client terminal.

Optionally, the user identification is one or more of a user account, a mobile phone number, or a client terminal's MAC address.

According to the method and device for pushing a reservation message, provided by the embodiments of the disclosure, a globally unique live video identification is set for a live video of each subsystem, so that after a reservation request of a client terminal is received, the reservation message may be transmitted to all associated second client terminals according to the live video identification, and a user may receive an alert message or a notification in real-time and synchronously on any terminal. Meanwhile, the notification of the reservation message is globally unique, so as to avoid repeated reminding of a same reservation event.

According to the embodiment of the disclosure, a non-transitory computer-readable storage medium is provided, and the non-transitory computer-readable storage medium stores executable instructions that, when executed by an electronic device, cause the electronic device to executing the method for pushing reservation message provided by the above embodiments of the disclosure.

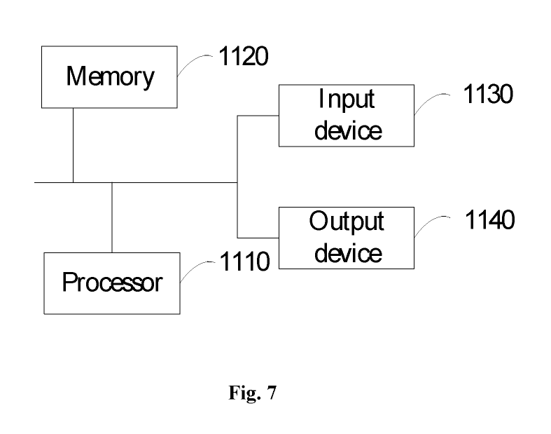

FIG. 7 is a schematic diagram of the hardware structure of electronic device executing the method for pushing reservation message, provided by an embodiment of the disclosure. As shown in FIG. 7, the device comprises one or more processors 1110 and a memory 1120. A case of one processor 1110 is taken as an example in FIG. 7.

The device executing the method for pushing a reservation message further comprises an input device 1130 and an output device 1140.

The processor 1110, the memory 1120, the input device 1130 and the output device 1140 may be connected through a bus or in other ways. A case of bus connection is taken as an example in FIG. 7.

As a non-transitory computer-readable storage medium, the memory 1120 can be used for storing non-transitory software programs, non-transitory computer executable programs and modules, such as program instructions/modules (i.e., the receiving module 31, the determining module, the processing module 33 and the pushing module 34 as shown in FIG. 3) corresponding to the method for pushing a reservation message described in the embodiment of the disclosure.

The memory 1120 further comprises a program storage area and a data storage area, wherein the program storage area can store an operating system or application programs required by at least one function, and the data storage area can store data, etc., created according to using of the device for pushing a reservation message. In addition, the memory 1120 may include a high speed random access memory and further may include a non-transitory memory, such as at least one disk memory, a flash memory, or other non-transitory solid-state memories. In some embodiments, the storage 1120 optionally include memories set up remotely relative to the processor 1110, and these remote memories can be connected to the device for pushing a reservation message through a network. The above-mentioned networks include but are not limited to the Internet, Intranet, LAN, mobile communication networks and a combination thereof.

The input device 1130 can receive input figure or character information and generate key signal inputs in connection with user settings and function control of the device for pushing a reservation message. The output device 1140 may include display devices such as a display screen.

The one or more modules are stored in the memory 1120 and are used for executing the method for pushing a reservation message disclosed in any of the above-mentioned method embodiments when executed by one or more processors 1110.

The above-mentioned product can execute the method provided by the embodiments of the disclosure and has corresponding functional modules executing the method and beneficial effects. The technical details not described in the embodiment in detail are available with reference to the method provided by the embodiments of the disclosure.

The electronic device in the embodiments of the disclosure exists in many forms, including but not limited to:

Mobile communication equipment: this type of device is featured with a mobile communication function, and is mainly used for providing voice and data communication. These terminals include: a smartphone (e.g. iPhone), a multimedia phone, a functionality phone, and a low-end phone, and the like.

Ultra mobile personal computer equipment: this type of equipment belongs to the range of personal computers, and is provided with computation and processing functions, and typically has a mobile internet characteristic. These terminals include: PDA, MID and UMPC equipment, and the like, such as iPad.

Portable recreation equipment: this type of equipment can display and play multimedia contents. This type of equipment include: voice and audio players (such as iPod), handheld game players, e-books, intelligent toys and portable vehicle navigation equipment.

Servers: apparatus can provide computing service, and servers include: processors, hard disks, memories, system buses and the like, architecture of the servers is similar to that of a general-purpose computer, however, due to requirement for providing high-quality and reliable service, the requirements on processing capability, stability, reliability, safety, expandability, manageability and other aspects are higher.

Other electronic devices with a data interaction function.

The device embodiments described above are merely exemplary, wherein units described as separated components can be or cannot be separated physically, components displayed as units can be or cannot be physical units, namely can be located in one place, or can be distributed on multiple network units. The object of the solution of the embodiments can be achieved by selecting part or all of modules according to practical demands.

Based on the above description of the embodiments, it can be clearly appreciated by person skilled in the art that the embodiments can be implemented in a way of combination of software and a universal hardware platform or through hardware certainly. Based on such understanding, the nature of the above-mentioned technical solution or its part making contribution to relevant technology can be embodied in form of software. The computer software product can be stored in a computer-readable storage medium, such as ROM/RAM, a disk, CD, etc. and comprises a plurality of instructions for enabling one set of computer equipment (which may be a personal computer, a server or network equipment, etc.) to execute the method described in all embodiments or in part of an embodiment.

Finally, it should be noted that the above-mentioned embodiments are only used for explaining the technical solution of this application but not for limiting it. Even though this application has been described in detail with reference to the aforesaid embodiments, it should be understood that person skilled in the art still can modify the technical solutions disclosed in the above-mentioned embodiments or make equivalent substitutions to part of technical features; and these modifications or substitutions will not depart the corresponding technical solutions essentially from the spirit and scope of the technical solutions of all embodiments of this application.

What is claimed is:

1. A method for pushing reservation message, executed by a server, comprising:
receiving a reservation request to subscribe to a live video sent by a first client terminal, the reservation request comprising a user identification and a live video identification which globally uniquely corresponds to the live video;
determining a user reservation relationship according to the reservation request, where the user reservation relationship comprises one or more client terminals associated with the user identification;
after an event update notification of the live video is received, determining the user identification to which the reservation message is needed to be pushed according to the live video identification, and determining a second client terminal to which the reservation message is needed to be pushed according to the user reservation relationship; and
pushing a reservation message of the live video to the second client terminal, and indicating the second client terminal to play the live video according to the reservation message.

2. The method according to claim 1, wherein also comprising:
acquiring same or different video flags of a live video in different subsystems, and globally unifying all video flags of the live video into a same live video identification.

3. The method according to claim 1, wherein determining a second client terminal to which the reservation message is needed to be pushed according to the user reservation relationship comprises:
determining one or more client terminals associated with the user identification according to the user reservation relationship; and
selecting a client terminal in a logged-in state as the second client terminal to which the reservation message is needed to be pushed.

4. The method according to claim 3, wherein selecting a client terminal in a logged-in state as the second client terminal to which the reservation message is needed to be pushed comprises:
determining client terminals in the logged-in state according to the user identification; and
selecting one client terminal from the client terminals in the logged-in state according to a preset rule, and taking the selected client terminal as a second client terminal.

5. The method according to claim 1, wherein the user identification is one or more of a user account, a mobile phone number, or a client terminal's MAC address.

6. A non-transitory computer-readable storage medium storing executable instructions that, when executed by an electronic device, cause the electronic device to:
receive a reservation request to subscribe to a live video sent by a first client terminal, the reservation request comprising a user identification and a live video identification which globally uniquely corresponds to the live video;
determine a user reservation relationship according to the reservation request, where the user reservation relationship comprises one or more client terminals associated with the user identification;
after an event update notification of the live video is received, determine the user identification to which the reservation message is needed to be pushed according to the live video identification, and determine a second client terminal to which the reservation message is needed to be pushed according to the user reservation relationship; and
push a reservation message of the live video to the second client terminal, and indicate the second client terminal to play the live video according to the reservation message.

7. The non-transitory computer-readable storage medium according to claim 6, the said instructions is used for causing the electronic device to:
acquire same or different video flags of a live video in different subsystems, and globally unify all video flags of the live video into a same live video identification.

8. The non-transitory computer-readable storage medium according to claim 6, the said instructions is used for causing the electronic device to:
determine one or more client terminals associated with the user identification according to the user reservation relationship; and
select a client terminal in a logged-in state as the second client terminal to which the reservation message is needed to be pushed.

9. The non-transitory computer-readable storage medium according to claim 8, the said instructions is used for causing the electronic device to:
determine client terminals in the logged-in state according to the user identification; and
select one client terminal from the client terminals in the logged-in state according to a preset rule, and take the selected client terminal as a second client terminal.

10. The non-transitory computer-readable storage medium according to claim 6, wherein the user identification is one or more of a user account, a mobile phone number, or a client terminal's MAC address.

11. An electronic device, comprising:
at least one processor; and
a memory communicably connected with the at least one processor for storing instructions executable by the at least one processor, wherein execution of the instructions by the at least one processor causes the at least one processor to:
receive a reservation request to subscribe to a live video sent by a first client terminal, the reservation request comprising a user identification and a live video identification which globally uniquely corresponds to the live video;
determine a user reservation relationship according to the reservation request, where the user reservation relationship comprises one or more client terminals associated with the user identification;
after an event update notification of the live video is received, determine the user identification to which the reservation message is needed to be pushed according to the live video identification, and determine a second client terminal to which the reservation message is needed to be pushed according to the user reservation relationship; and
push a reservation message of the live video to the second client terminal, and indicate the second client terminal to play the live video according to the reservation message.

12. The electronic device according to claim 11, wherein execution of the instructions by the at least one processor causes the at least one processor to:
acquire same or different video flags of a live video in different subsystems, and globally unify all video flags of the live video into a same live video identification.

13. The electronic device according to claim 11, wherein execution of the instructions by the at least one processor causes the at least one processor to:
determine one or more client terminals associated with the user identification according to the user reservation relationship; and
select a client terminal in a logged-in state as the second client terminal to which the reservation message is needed to be pushed.

14. The electronic device according to claim 13, wherein execution of the instructions by the at least one processor causes the at least one processor to:
determine client terminals in the logged-in state according to the user identification; and
select one client terminal from the client terminals in the logged-in state according to a preset rule, and take the selected client terminal as a second client terminal.

15. The electronic device according to claim 11, wherein the user identification is one or more of a user account, a mobile phone number, or a client terminal's MAC address.
